(19) United States
(12) Patent Application Publication
(10) Pub. No.: US 2026/0022027 A1
(43) Pub. Date: Jan. 22, 2026

(54) MANUFACTURING METHOD OF BaZrTiO3 DIELECTRIC CERAMICS

(71) Applicant: Korea Institute of Ceramic Engineering & Technology, Jinju-si (KR)

(72) Inventors: Moon Hee Choi, Jinju-si (KR); Sang Soo Chee, Jinju-si (KR); Wol Il Nam, Jinju-si (KR); Ji Hye Seo, Jinju-si (KR); Yu Na Hwang, Jinju-si (KR); Min Jeong Kim, Jinju-si (KR); Ji Hyun Park, Jinju-si (KR); Seok Ha Heo, Jinju-si (KR)

(21) Appl. No.: 19/248,728

(22) Filed: Jun. 25, 2025

(30) Foreign Application Priority Data
Jul. 19, 2024 (KR) 10-2024-0095921

(51) Int. Cl. C01G 25/00; H01G 4/12

(52) U.S. Cl. CPC C01G 25/006; C01P 2002/72; C01P 2004/03; C01P 2004/04; C01P 2006/40; H01G 4/1245

(57) ABSTRACT

A method for manufacturing BaZrTiO₃ dielectric ceramics according to the present invention is disclosed. The method comprises (i) preparing BaCO₃ raw material powder, TiO₂ raw material powder, and ZrO₂ raw material powder, respectively, wherein the TiO₂ raw material powder is prepared as an anatase single-phase TiO₂ powder; (ii) producing a composite-phase TiO₂ powder by heat-treating the anatase single-phase TiO₂ powder to induce a phase transition, so that the internal structure of a particle of the composite-phase TiO₂ powder is composed of a core/shell structure in which an anatase-phase TiO₂ region/a brookite-phase TiO₂ region/a rutile-phase TiO₂ region are laminated, wherein the brookite-phase TiO₂ region is a hybrid region in which the anatase-phase TiO₂ region and the rutile-phase TiO₂ region are coexisting; (iii) mixing the BaCO₃ raw material powder, the composite-phase TiO₂ powder, and the ZrO₂ raw material powder, and heat-treatment calcining the mixed powder to synthesize BaZrTiO₃ powder; and (iv) molding the synthesized BaZrTiO₃ powder and sintering the molded body to form a BaZrTiO₃ solid solution.

### FIELD OF THE INVENTION

The present invention was made with the government support under Grant No. RS-2025-02305079 “Development of Ultralow Dielectric and High Strength LTCC Materials and Modules for Ka-/E-band compatible 6G Communication” awarded by Ministry of Science and ICT (MSIT) of Korea.

The present invention relates to a method for manufacturing BaZrTiO₃ dielectric ceramics capable of implementing a colossal dielectric constant while having a low dielectric loss.

### BACKGROUND OF THE INVENTION

Multilayer ceramic capacitors (MLCCs), which accounts for more than 70% of the entire capacitor market, are essential and general-purpose passive components used in all electronic devices.

Typically, in manufacturing such MLCCs, barium titanate (BaTiO₃) ferroelectric powder is most commonly used. Barium titanate is a ferroelectric material having a high dielectric constant of approximately 1,700 at room temperature and an ABO₃ perovskite structure.

However, with the recent trend toward higher performance of electronic devices for ultra-high-speed signal processing and higher voltage of energy storage and conversion devices, so-called colossal dielectrics having an ultra-high dielectric constant (εᵣ) of approximately 10⁴ or higher, which far exceeds the dielectric constant of the barium titanate, and a low dielectric loss (tanδ) of approximately 10⁻³ or lower are desired as capacitor materials.

However, those dielectrics with ultra-high dielectric constant of 10⁴ or higher reported so far generally have high dielectric loss, making them difficult to be practically applied as capacitors. Therefore, recent research has been focused on improving the compositions of Relaxor ferroelectrics with low dielectric loss.

The recent studies by the present inventors have observed that when adding Zr to the barium titanate (BaTiO₃) and substituting Ti at the B site, it induces lattice expansion and lattice structure change due to the substitution of Zr⁴⁺, which has a larger ionic radius (0.72Å) than that of Ti⁴⁺ (0.605Å), thereby improving the dielectric properties to reach an ultra-high dielectric constant of up to approximately 2×10⁴. However, this dielectric still exhibits a dielectric loss of approximately 10⁻², necessitating further improvement.

### Prior Art Documents

1. KR Laid-open Patent Publication No. 10-2014-0015073 (laid open on Feb. 6, 2014)
2. JP Laid-open Patent Publication No. 2015-35574 (laid open on Feb. 19, 2015)
3. Moonhee Choi et al., “Systematic determination of the optimized Zr content of Ba(ZrxTi1-x)O3 with high dielectric constant at room temperature for high voltage system application”, J. Korean Ceram. Soc., 61, 391-401 (2024)
4. US Patent Publication No. 11,958,755 B2 (published on Apr. 16, 2024)

### SUMMARY OF THE INVENTION

Hence, the present invention is directed to provide a method for manufacturing BaZrTiO₃ dielectric ceramics capable of implementing a colossal dielectric constant while having a low dielectric loss.

The method for manufacturing BaZrTiO₃ dielectric ceramics of the present invention for solving the above problems comprises the following steps (i) to (iv):
(i) preparing BaCO₃ raw material powder, TiO₂ raw material powder, and ZrO₂ raw material powder, respectively, wherein the TiO₂ raw material powder is prepared as an anatase single-phase TiO₂ powder;
(ii) producing a composite-phase TiO₂ powder by heat-treating the anatase single-phase TiO₂ powder to induce a phase transition, so that the internal structure of a particle of the composite-phase TiO₂ powder is composed of a core/shell structure in which an anatase-phase TiO₂ region/a brookite-phase TiO₂ region/a rutile-phase TiO₂ region are laminated, wherein the brookite-phase TiO₂ region is a hybrid region in which the anatase-phase TiO₂ region and the rutile-phase TiO₂ region are coexisting;
(iii) mixing the BaCO₃ raw material powder, the composite-phase TiO₂ powder, and the ZrO₂ raw material powder, and heat-treatment calcining the mixed powder to synthesize BaZrTiO₃ powder; and
(iv) molding the synthesized BaZrTiO₃ powder and sintering the molded body to form a BaZrTiO₃ solid solution.

Here, optionally, the core/shell structure of the step (ii) may be a structure in which from the core toward the shell, the occupancy of the anatase-phase TiO₂ region decreases, while the occupancy of the rutile-phase TiO₂ region increases.

In addition, optionally, the occupancy ratio of the anatase phase TiO₂ region vs. the rutile phase TiO₂ region in the core/shell structure of the step (ii) may be adjusted in the range of 10:90 to 90:10.

In addition, optionally, the ratio of the occupancy of the anatase-phase TiO₂ region to the rutile-phase TiO₂ region in the core/shell structure of the step (ii) may be adjusted by controlling the temperature of the heat-treating in the step (ii).

In addition, optionally, the temperature at which the heat-treating in the step (ii) is performed may be controlled within a temperature range of 600 to 900° C. In addition, optionally, the heat-treating in the step (ii) may be performed for 5 to 9 hours.

In addition, optionally, the heat-treatment calcining in the step (iii) may be performed within a temperature range of 1000 to 1400° C.

In addition, optionally, in the step (iv), the sintering may be performed within a temperature range of 1000 to 1400° C.

In addition, optionally, the heat-treating in the step (ii) may be performed within a temperature range of 600 to 900° C. and the heat-treatment calcining in the step (iii) may be performed within a temperature range of 1000 to 1100° C., wherein the BaZrTiO₃ solid solution sintered in the step (iv) has a dielectric constant in the range of 2.0×10⁴ to 3.3×10⁴.

In addition, optionally, by controlling the temperature at which the heat-treating is performed in the step (ii), the occupancy ratio of the anatase phase TiO₂ region to the rutile phase TiO₂ region in the core/shell structure may be adjusted, thereby controlling one or both of the dielectric constant and the dielectric loss of the BaZrTiO₃ solid solution in the step (iv).

In addition, optionally, the temperature at which the heat-treatment calcining is performed in the step (iii) may be further adjusted, thereby controlling one or both of the dielectric constant and dielectric loss of the BaZrTiO₃ solid solution in step (iv).

In addition, optionally, in the step (iv), the molding may be performed by one or more among dry molding, uniaxial molding, cold isostatic pressing (CIP), extrusion forming or tape casting to form the formed body into one or both of a bulk and a thick film.

In addition, optionally, the BaZrTiO₃ powder synthesized in the step (iii) is prepared as a slurry in which the powder is dispersed in a solvent, and the molding in the step (iv) may include a step of forming a plurality of green sheets by tape casting the slurry and printing metal electrode patterns on the surfaces of at least a portion of the plurality of green sheets, and a step of laminating and compressing the plurality of green sheets to form the molded body integrated into one bulk, i.e. a monolithic body.

According to the present invention, by employing the three-phase (or “triphase”) core/shell TiO₂ powder as a starting material, BaZrTiO₃ dielectric ceramics exhibits remarkably large grain growth within their internal structures and their dielectric properties are significantly improved compared to those of when using conventional anatase or rutile single-phase TiO₂ raw material powders as starting materials, so that in particular the BaZrTiO₃ dielectric ceramics have ultra-high dielectric constant and very low dielectric loss. Such BaZrTiO₃ colossal-dielectric constant material of the present invention has an ultra-high dielectric constant of up to about 33,560 and a very low dielectric loss of about 1×10⁻³ at minimum and therefore can be very advantageously applied to various high-performance electronic devices and energy storage and conversion devices.

### BRIEF DESCRIPTION OF THE DRAWINGS

FIG. 1 is a flow chart explaining a manufacturing process of BaZrTiO₃ dielectric ceramics according to the present invention.

FIG. 2 is a graph explaining the phase change of the internal structure of the TiO₂ powder particles at each temperature segment during the heat treatment of the anatase-phase TiO₂ powder according to the temperature profile in an embodiment of the present invention.

FIG. 3 is the photographic results of the TEM diffraction pattern analysis of TiO₂ powder particles heat-treated at 850° C. for 5 hours according to the temperature profile of FIG. 2.

FIGS. 4A˜4B are results of analyzing the phase changes of the internal structure of TiO₂ powder particles heat-treated according to the temperature profile of FIG. 2, each by holding at 800° C. for 1 hour, at 800° C. for 5 hours, at 850° C. for 1 hour, at 850° C. for 9 hours, and at 900° C. for 1 hour each. FIG. 4A shows an X-ray diffraction pattern of the heat-treated TiO₂ powder particles, and FIG. 4B shows a diagram of the change in the occupancy ratio of the anatase phase region to the rutile phase region in the internal structure of the heat-treated TiO₂ powder particles.

FIG. 5 shows the results of X-ray diffraction analysis of the internal structure of BaZrTiO₃ powder, which was synthesized in a solid phase by mixing TiO₂ raw material powder with BaCO₃ powder and ZrO₂ powder as varying the phase fractions of anatase-phase TiO₂:rutile-phase TiO₂ in the internal structure of TiO₂ raw material powder at about 100:0 [(a)], about 84.57:15.43 [(b)], about 12.76:87.24 [(c)], and about 0:100 [(d)], respectively, and then calcining the mixed powder at about 1000 to 1400° C. for about 2 hours in an air atmosphere, according to the embodiments of the present invention.

FIG. 6 shows the SEM images analyzing the microstructure of BaZrTiO₃ powder, which was synthesized in a solid phase by mixing TiO₂ raw material powder with BaCO₃ powder and ZrO₂ powder as varying the phase fractions of anatase-phase TiO₂:rutile-phase TiO₂ in the internal structure of TiO₂ raw material powder as about 100:0 [(a-1); (b-1); (c-1); (d-1)], about 80:20 [(a-2; (b-2); (c-2); (d-2)], about 20:80 [(a-3); (b-3); (c-3); (d-3)], and about 0:100 [(a-4); (b-4); (c-4); (d-4)] respectively, and then calcining the mixed powder at about 1000° C., 1100° C., 1200° C., and 1300° C. for about 2 hours in an air atmosphere, according to the embodiments of the present invention.

FIG. 7 is a graph showing the change of density by each composition and by each calcination temperature of BaZrTiO₃ solid solutions (“BZT”), which was manufactured by molding BaZrTiO₃ powder calcined for each composition in FIG. 6 to form a BaZrTiO₃ bulk and sintering each of the BaZrTiO₃ bulk at about 1300° C. for 2 hours in an air atmosphere, according to embodiments of the present invention.

FIG. 8 is SEM photographs of each fracture surface of a BaZrTiO₃ solid solution (“BZT”) analyzing the microstructure by composition according to the calcination temperature, which was manufactured by molding BaZrTiO₃ powder calcined at 1000 to 1200° C. to form a BaZrTiO₃ bulk, among the BaZrTiO₃ powders calcined by each composition in FIG. 5, and sintering the BaZrTiO₃ bulk at about 1300° C. for 2 hours in an air atmosphere, according to embodiments of the present invention.

FIG. 9 is a graph showing the change in dielectric constant (ε) of BaZrTiO₃ solid solutions by the composition and by the calcination temperature, which were manufactured by sintering BaZrTiO₃ bulks formed by molding BaZrTiO₃ powders calcined according to each composition in FIG. 6 at about 1300° C. for 2 hours in an air atmosphere, respectively, according to embodiments of the present invention, wherein (a) to (d) are each of the BaZrTiO₃ solid solutions manufactured by applying composite-phase TiO₂ powders as starting materials with varied anatase-phase:rutile-phase fractions, and wherein (a) indicates the case when an anatase single-phase TiO₂ powder of a 100:0 anatase:rutile phase fraction was applied as a starting material, (b) indicates the case when an anatase/brookite/rutile triphase core/shell TiO₂ powder of a 80:20 anatase:rutile phase fraction was applied as a starting material, and (c) indicates the case when an anatase/brookite/rutile triphase core/shell TiO₂ powder of a 20:80 anatase:rutile phase fraction was applied as a starting material, and (d) indicates the case when a rutile single-phase TiO₂ powder of a 0:100 anatase:rutile phase fraction was applied as starting materials, respectively.

FIGS. 10A˜10B are graphs showing changes in dielectric properties by composition and by calcination temperature of BaZrTiO₃ solid solutions which were manufactured by molding BaZrTiO₃ powders calcined by each composition in FIG. 5 to form BaZrTiO₃ bulks and sintering the BaZrTiO₃ bulks at about 1300° C. for 2 hours in an air atmosphere, according to embodiments of the present invention, wherein FIG. 10A shows the changes in dielectric constant (ε) and FIG. 10B shows the changes in dissipation factor. And, here, #1˜#4 are each of the BaZrTiO₃ solid solutions manufactured by applying TiO₂ powders as starting materials with varying anatase:rutile phase fractions, wherein #1 indicates the case when anatase single-phase TiO₂ powder of a 100:0 anatase:rutile phase fraction was applied as starting materials, #2 indicates the case when anatase/brookite/rutile triphase core/shell TiO₂ powder of a 85:15 anatase:rutile phase fraction was applied as starting materials, #3 indicates the case when anatase/brookite/rutile triphase core/shell TiO₂ powder of a 13:87 anatase:rutile phase fraction was applied as starting materials, and #4 indicates the case when anatase single-phase TiO₂ powder of a 0:100 anatase:rutile phase fraction was applied as starting materials, respectively.

### DETAILED DESCRIPTION OF THE PREFERRED EMBODIMENTS

In general, a process for manufacturing BaZrTiO₃ dielectric ceramics by an oxide mixing method may include the steps of (i) preparing raw material powders, (ii) mixing the raw material powders, (iii) calcining the mixed powders to synthesize BaZrTiO₃ powder, (iv) molding the synthesized BaZrTiO₃ powder, and (v) sintering the molded body to form a BaZrTiO₃ solid solution.

Among the above steps, the present invention particularly focuses on the preparation of TiO₂ powder in the step (i) of preparing raw material powders.

In general, TiO₂ is known to have various forms. TiO2 exists as a rutile phase, an anatase phase, or a brookite phase depending on its own crystal structure. The anatase phase has a tetragonal unit cell having four TiO₂ units, the rutile phase has a tetragonal unit cell having two TiO₂ units, and the brookite phase has an orthorhombic unit cell having eight TiO₂ units, respectively. The brookite phase is extremely difficult to manufacture as a pure lattice structure in which the anatase and rutile phases are not coexisting and hence it is generally more unstable than the rutile phase structure due to the stress resulting from the lattice mismatch between those internally coexisting anatase and rutile phases.

In general, TiO₂ is most stable in the rutile phase structure at the atmospheric pressure and the room temperature, and the anatase phase and brookite phase structures are metastable, so that they are converted to the rutile phase through an irreversible process at high temperatures.

In light of this, in the process for manufacturing BaZrTiO₃ dielectric ceramics, the present invention firstly prepare the TiO₂ raw material powder to be used as the anatase-phase TiO₂ powder and heat-treat the same at a predetermined temperature for a predetermined period of time to deliberately cause a phase transformation in the anatase-phase TiO₂ powder, thereby providing TiO₂ powder particles as a TiO₂ starting material, having a composite core/shell internal structure in which those anatase/brookite/rutile phases are coexisting.

That is, in the present invention, the more directly the anatase-phase TiO₂ powder particles receive the heat applied by the heat treatment, the more easily their corresponding portions can be converted from the anatase phase to the rutile phase. Hence, depending on the applied heat and time, the internal structure of the TiO₂ powder particles is converted into a so-called three-phase (or “triphase”) core/shell structure in which the internal structure sequentially changes into the anatase phase region—brookite phase region—rutile phase region from the center (core) to the surface (shell) of the TiO₂ powder particles.

As will be described in detail in conjunction with the embodiments, as a starting material in the aforementioned general manufacturing process, the present invention uses the TiO₂ powder with an anatase/brookite/rutile triphase core/shell structure resulting from such deliberate phase transformations, which may produce BaZrTiO₃ dielectric ceramics having significantly improved dielectric properties of particularly low dielectric loss and ultra-high dielectric constant, compared to conventional BaZrTiO₃ dielectric ceramics.

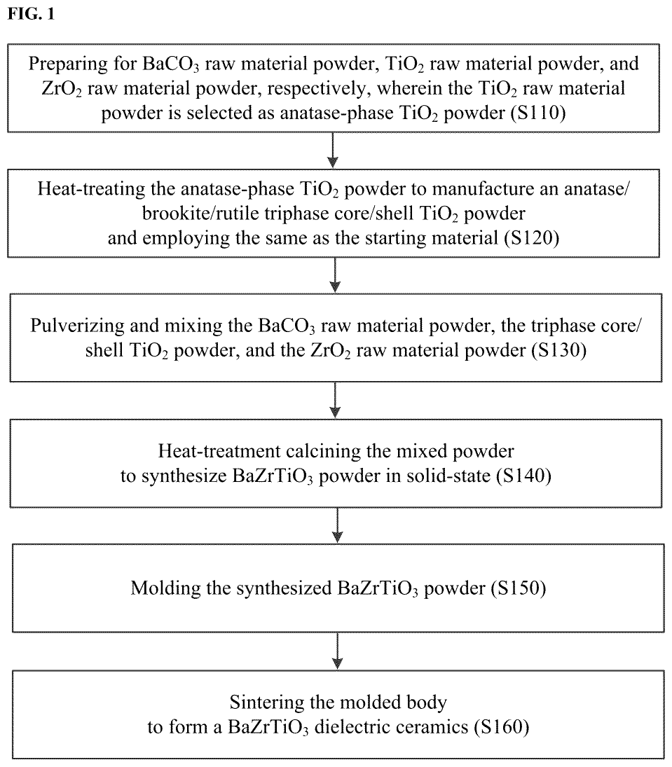

As such, the manufacturing process of BaZrTiO₃ dielectric ceramics according to the present invention comprises the following steps. FIG. 1 is a flow chart summarizing such a manufacturing process according to the present invention:
(i) preparing for BaCO₃ raw material powder, TiO₂ raw material powder, and ZrO₂ raw material powder, respectively, wherein the TiO₂ raw material powder is selected as anatase-phase TiO₂ powder (S110);
(ii) manufacturing TiO₂ powder having an anatase/brookite/rutile triphase core/shell structure through deliberate phase transformation by heat-treating the anatase-phase TiO₂ powder under predetermined temperature and time conditions (S120);
(iii) mixing the BaCO₃ raw material powder, the triphase core/shell TiO₂ powder, and the ZrO₂ raw material powder (S130);
(iv) heat-treatment calcining the above mixed powder to synthesize BaZrTiO₃ powder (S140);
(v) molding the synthesized BaZrTiO₃ powder (S150); and
(vi) sintering the molded body to form a BaZrTiO₃ solid solution (S160).

Hereinafter, the manufacturing steps of the present invention will be described in detail.

### Heat Treatment of TiO₂ Raw Powder (S120)

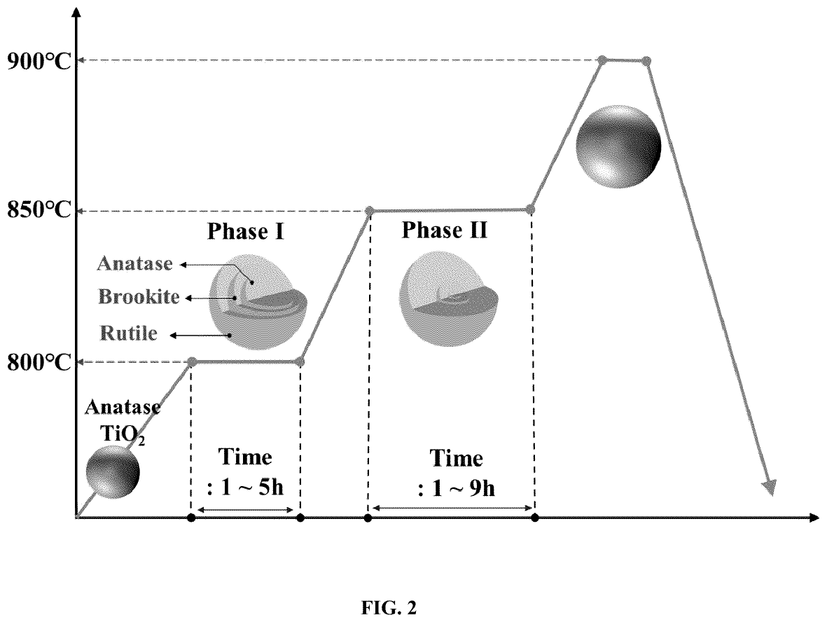

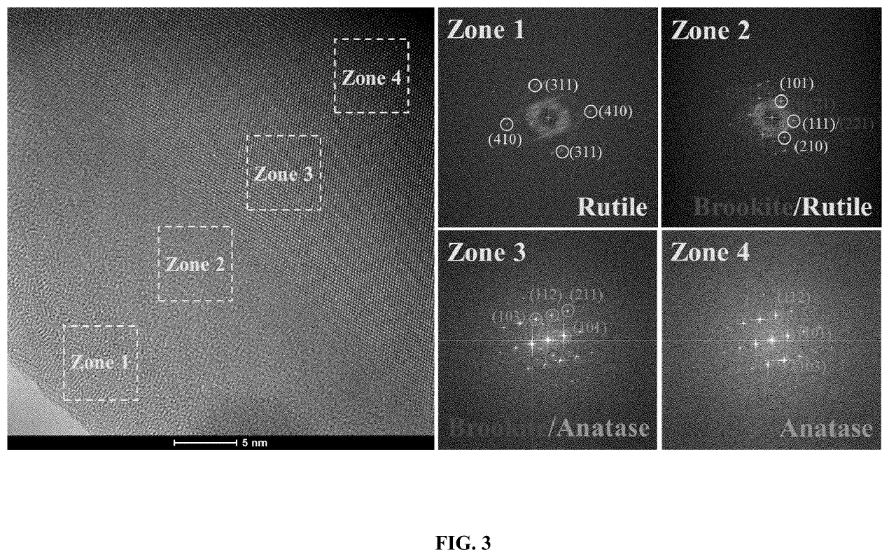

According to the step (ii) in the present invention of manufacturing TiO₂ powder having an anatase/brookite/rutile triphase core/shell structure by heat-treating the anatase-phase TiO₂ powder (S120), FIG. 2 is a graph explaining the phase change of the internal structure of the TiO₂ powder particles at each temperature segment by heat-treating the anatase-phase TiO₂ powder according to the temperature profile in an embodiment of the present invention.

FIG. 3 is a photograph showing the results of a TEM diffraction pattern analysis of TiO₂ powder particles which were heat-treated at 850° C. for 5 hours according to the temperature profile of FIG. 2.

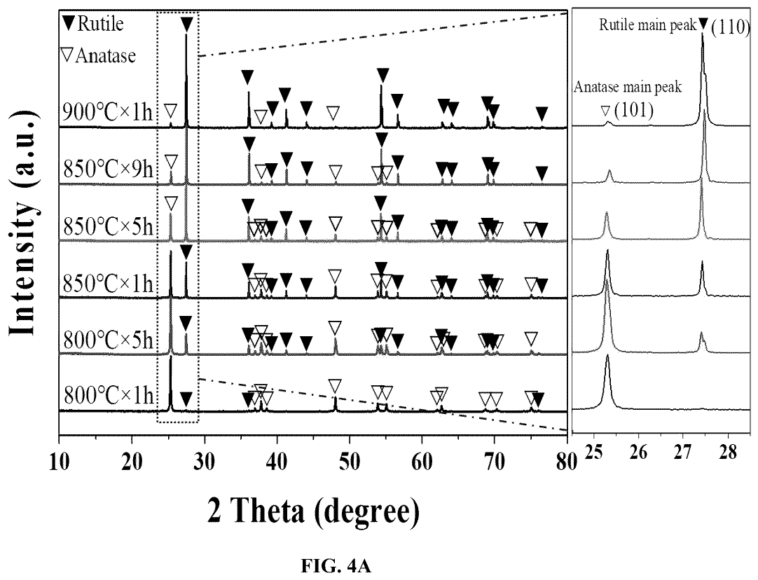

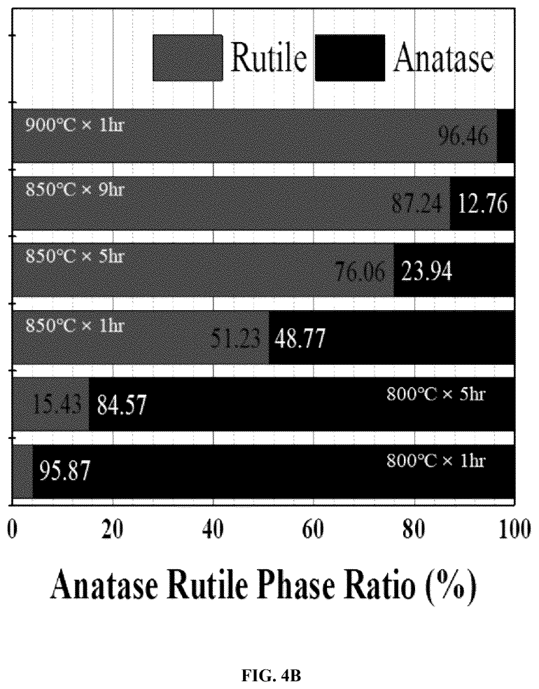

FIGS. 4A˜4B are results of analyzing the phase changes of the internal structure of the heat-treated TiO₂ powder particles by holding at 800° C. for 1 hour, holding at 800° C. for 5 hours, holding at 850° C. for 1 hour, holding at 850° C. for 9 hours, and holding at 900° C. for 1 hour, respectively, according to the temperature profile of FIG. 2, wherein FIG. 4A shows an X-ray diffraction analysis pattern of the heat-treated TiO₂ powder particles and FIG. 4B shows a diagram of the changes in the occupancy ratio of the anatase-phase region to the rutile-phase region in the internal structure of the heat-treated TiO₂ powder particles, respectively.

Referring to FIG. 2, TiO₂ powder particles which were a single-phase anatase can be converted into a composite-phase core/shell structure, i.e. a triphase core/shell TiO₂ powder particle of anatase/brookite/rutile, in a heat treatment temperature segment of about 800° C. (“Phase I”). Furthermore, when the temperature is increased to a temperature segment of about 850° C. (“Phase II”), then the anatase-phase TiO₂ region in the triphase core/shell structure decreases and instead the structure begins to be converted into a triphase core/shell structure in which the rutile-phase TiO₂ region is expanded, and further, when the temperature is increased to a temperature segment of about 900° C., then the anatase phase TiO₂ region disappears and the particles are converted into a single rutile-phase TiO₂ powder particles.

Referring to FIG. 3 which shows TEM images of each part of the heat-treated TiO₂ powder particles, the more directly the heat being applied by the heat treatment is received, the more easily the corresponding TiO₂ part can be converted from the anatase phase to the rutile phase. Therefore, the internal structure of the TiO₂ powder particles shows a change in phase, in which the anatase-phase area gradually decreases, whereas the rutile-phase area gradually increases sequentially as moving from the core part (“Zone 4”) to the shell part (“Zone 1”), that is, as moving to Zone 4-3-2-1. As seen in FIG. 3, Zone 1 (shell), which was directly exposed to heat, converted to rutile-phase TiO₂, and Zones 2˜3, which were subjected to relatively lower heat transfer, converted to brookite-phase TiO₂ which is less stable than the rutile phase due to the coexistence of the anatase and the rutile phases. On the other hand, Zone 4 (core), which was hardly influenced by heat transfer, is observed to still remain as anatase-phase TiO₂.

And, such phase changes are also confirmed in FIGS. 4A˜4B. That is, when anatase-phase TiO₂ powder particles with a size of about 80 nm were heat-treated at about 800° C. for about 1 hour, the analysis results confirmed that the TiO₂ powder particles exhibit a typical main peak of the anatase structure (“▾” within the dotted square labeled “800° C.×1 h” in FIG. 4A) along with about 4.1% of the coexisting rutile-structure TiO₂. On the other hand, when the anatase-phase TiO₂ powder particles are heat-treated at about 800° C. for about 5 hours, the analysis results confirmed that the TiO₂ particles are composed of anatase/rutile composite-phase TiO₂ in which about 15.43% of the rutile structure TiO₂ coexists (FIGS. 4A˜4B). Furthermore, when elevating the heat treatment temperature to 850° C., followed by the heat treatment for about 1 to 9 hours, then a sharp growth of the main peak of rutile-phase TiO₂ (FIG. 4A) and an abrupt increase of rutile-phase TiO₂ to about 51.23˜87.24% (FIG. 4B) are resulted.

In the manufacture of BaZrTiO₃ dielectric ceramics according to the present invention, TiO₂ powder having an anatasc/brookite/rutile triphase core/shell structure produced through the heat treatment (S120) as described above is used as a starting material. In the present invention, the temperature range of the heat treatment is about 600 to 900° C., preferably about 800 to 850° C., and the time of the heat treatment is preferably about 5 to 9 hours.

### Synthesis of BaZrTiO₃ Powder (S140)

In the internal structure of the TiO₂ powder having an anatase/brookite/rutile triphase core/shell structure according to the present invention, the area occupancy ratio of the anatase-phase TiO₂ to the rutile-phase TiO₂ is approximately within the range of 10:90 to 90:10, preferably within the range of 13:87 to 85:15.

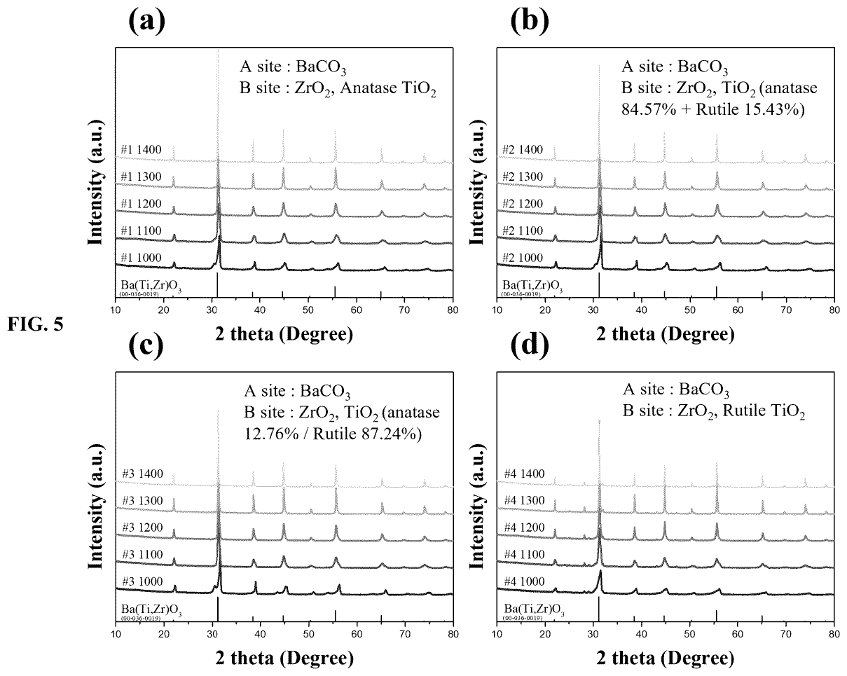

FIG. 5 shows the results of X-ray diffraction analysis by composition and by calcination temperature of the internal structure of BaZrTiO₃ powder, which was synthesized in a solid phase by initially producing TiO₂ raw material powder with varying the phase fractions of anatase-phase TiO₂:rutile-phase TiO₂ in its internal structure at about 100:0 [(a)], about 84.57:15.43 [(b)], about 12.76:87.24 [(c)], and about 0:100 [(d)], respectively, and subsequently mixing each of the TiO₂ powder with BaCO₃ powder and ZrO₂ powder, and then calcining each of the mixed powder at about 1000 to 1400° C. for about 2 hours in an air atmosphere, according to embodiments of the present invention.

Referring to FIG. 5, the X-ray diffraction analysis results of the solid-state synthesis powder for each condition, after completion of synthesis, confirm that each powder is BaZrTiO₃ having a typical cubic crystal structure. However, when rutile-phase TiO₂ was used as a starting material for the synthesis, the presence of some Ti-rich phases were observed after the synthesis.

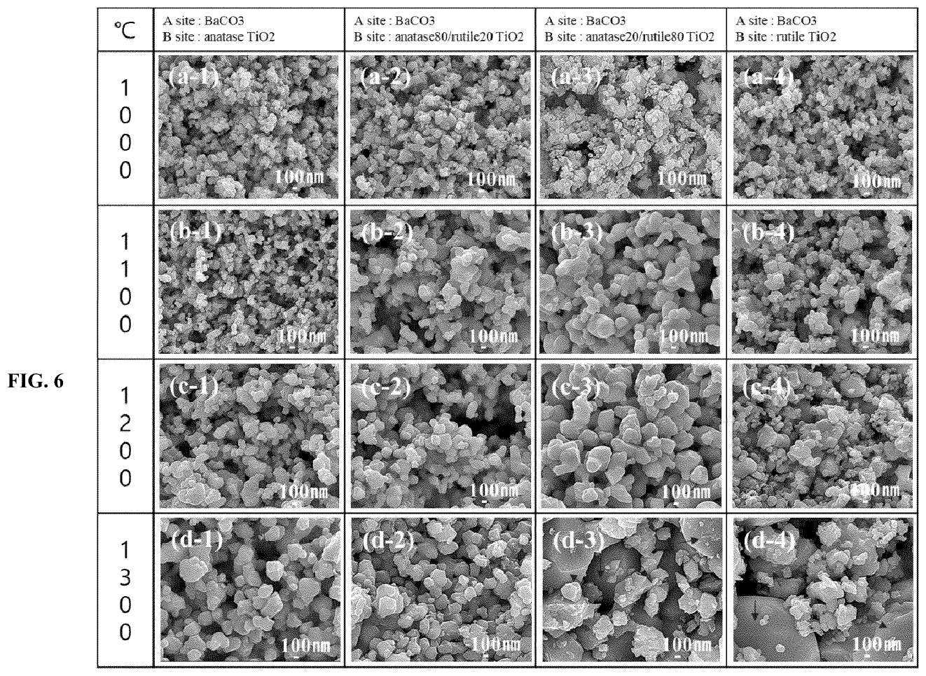

FIG. 6 shows the SEM photographs by composition and by calcination temperature analyzing the microstructure of BaZrTiO₃ powder, which was synthesized in a solid phase by initially producing TiO₂ raw material powder with varying the phase fractions of anatase-phase TiO₂:rutile-phase TiO₂ in its internal structure at about 100:0 [(a-1); (b-1); (c-1); (d-1)], about 80:20 [(a-2; (b-2); (c-2); (d-2)], about 20:80 [(a-3); (b-3); (c-3); (d-3)], and about 0:100 [(a-4); (b-4); (c-4); (d-4)], respectively, and subsequently mixing each of the TiO₂ powder with BaCO₃ powder and ZrO₂ powder, and then calcining each of the mixed powder at about 1000° C., 1100° C., 1200° C., and 1300° C. for about 2 hours in an air atmosphere, according to embodiments of the present invention.

Referring to FIG. 6, when the solid-state synthesis of BaZrTiO₃ was performed at approximately 1000° C. [(a-1)˜(a-4)], all the compositions were observed to be consisted of fine-sized powder particles. However, notably in the compositions using the anatase/brookite/rutile triphase core/shell TiO₂ powder [(a-2)˜(a-3)], grain growth was observed in some of the BaZrTiO₃ powder particles (as indicated by red arrows).

The reason why the solid-phase synthesis and the grain growth progress even at relatively low temperatures in a composition using composite-phase TiO₂ is attributed to the core/shell structure being formed through the controlled synthesis of the composite-phase TiO₂. That is, during the synthesis, a large amount of Ba²⁺and Zr⁴⁺ions are supplied to the surface of rutile-phase TiO₂, which has high surface energy, and the synthesis and the ionic substitution are accomplished at a rapid rate due to the anatase-phase core having relatively low density and unstable lattice structure.

Similarly, in case when the solid-state synthesis was performed at other calcination temperatures such as about 1100° C. and about 1200° C., in the composition using 100% anatase-phase TiO₂ powder, none of the grain growth of BaZrTiO₃ powder particles was observed [(b-1)] or the degree of grain growth was low [(c-1)], whereas in the compositions using triphase core/shell TiO₂ powder [(b-2)˜(b-3); (c-2)˜(c-3)], a relatively significant increase in the grain growth of BaZrTiO₃ powder particles was observed even at the same synthesis temperature, and as the fraction of the rutile-phase TiO₂ increased, the grain growth gradually increased.

Also, at higher synthesis temperatures such as approximately 1300° C., a significant increase in grain growth is observed in the composition using the triphase core/shell TiO₂ powder [(d-2)˜(d-3)], and as the higher the fraction of the rutile-phase TiO₂ increased, the more the coarse abnormal grain growth increased [(d-3), as indicated by the blue arrows)].

### Formation of the Solid Solution by Molding (S150) and Sintering (S160) of the Synthesized BaZrTiO₃ Powder

In the present invention, after the BaZrTiO₃ powder synthesized as described above is molded (S150), the molded body is sintered to form a solid solution (S160).

In the present invention, the molding may be performed by any known forming method including dry molding, uniaxial molding, cold isostatic pressing (CIP), extrusion forming, and tape casting to form a BaZrTiO₃ bulk or thick film. In one embodiment of the present invention, the molding may be performed by uniaxially pressing the synthesized BaZrTiO₃ powder into a pellet with a diameter of 100 at a pressure of 125 MPa for 1 minute to form a BaZrTiO₃ bulk. In addition, in another embodiment of the present invention, the BaZrTiO₃ powder is also manufactured as a viscous slurry in which the powder is uniformly dispersed in a solvent through addition and mixing of publicly-known binder, dispersant, solvent such as ethanol, and plasticizer as needed, and subsequently the slurry is formed into a thick green sheet by tape casting using a doctor blade or the like. Then, the green sheets are laminated in multiple layers in conformance to the designed structure of the final laminated device, or each green sheet get printed with metal electrode patterns on its surface and is alternately laminated and then being pressed to be integrated as a single bulk. This bulk is then heat-treated for sintering, so that it can be manufactured as a laminated device such as an MLCC (Multi-Layered Ceramic Capacitor).

Additionally, in one embodiment of the present invention, the sintering may be performed at a temperature range of about 1000 to 1400° C., preferably 1300° C., and in one example, the above temperature may be maintained for about 2 hours.

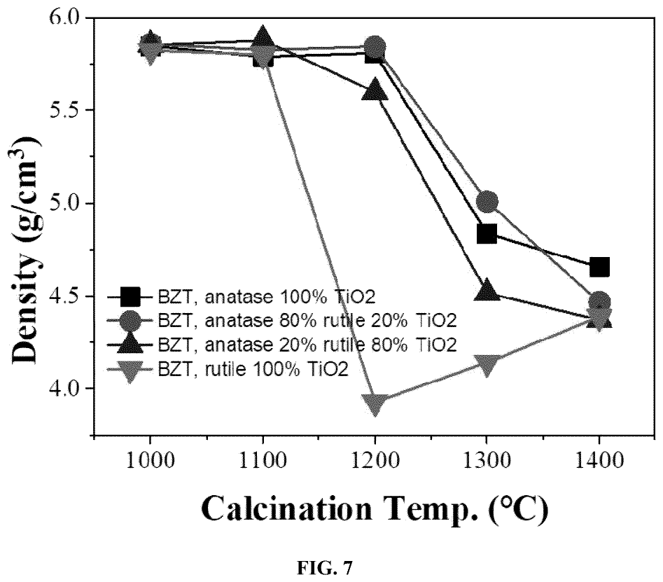

FIG. 7 is a graph showing the change of density by composition according to each calcination temperature of BaZrTiO₃ solid solutions (“BZT”), which was manufactured by molding BaZrTiO₃ powder calcined for each composition in FIG. 6 to form BaZrTiO₃ bulk and subsequently sintering the BaZrTiO₃ bulk at about 1300° C. for 2 hours in an air atmosphere, according to embodiments of the present invention.

Referring to FIG. 7, a sharp decrease in sintered density is observed in a composition using TiO₂ with a high rutile content and at a solid-state synthesis temperature of 1200° C. or higher.

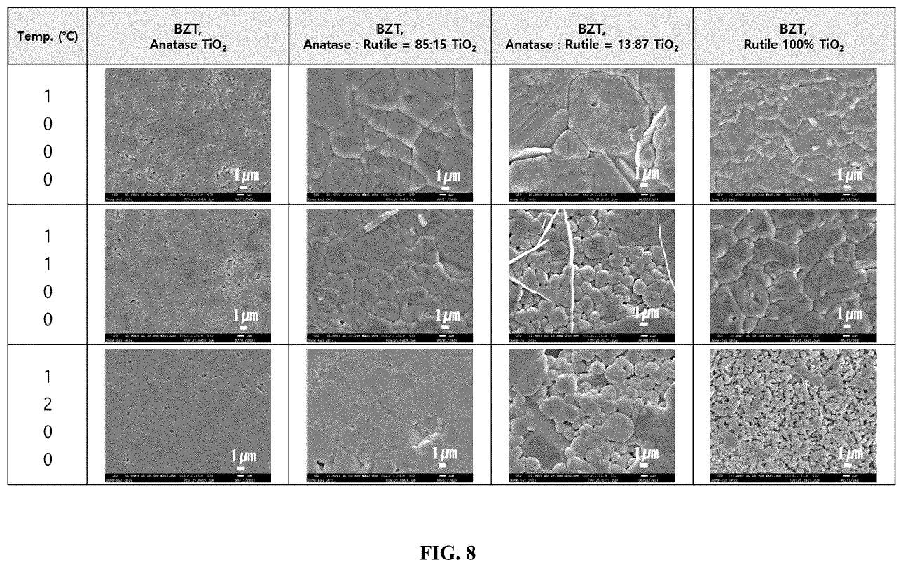

FIG. 8 is an SEM photograph of a cross-section of a BaZrTiO₃ solid solution (“BZT”) analyzing the microstructure by composition according to the calcination temperature, wherein BZT was manufactured by molding BaZrTiO₃ powder calcined at 1000 to 1200° C. among the BaZrTiO₃ powders calcined by each composition in FIG. 5 and subsequently sintering the molded body in an air atmosphere at about 1300° C. for 2 hours, according to embodiments of the present invention.

Referring to FIG. 8, in the solid-state BaZrTiO₃ solution synthesized at a temperature of 1000 to 1200° C. using 100% anatase-phase TiO₂ powder particles, it is observed that fine crystal grains were formed at a sintering temperature of 1300° C. On the other hand, in the BaZrTiO₃ solution where the triphase core/shell TiO₂ powder according to the present invention was employed under the same conditions, grain growth is observed. Generally, such grain growth in the internal structure enhances the dielectric constant of the dielectric material.

However, it is observed that grain growth does not occur in the BaZrTiO₃ solid solution which was synthesized in the solid phase at a temperature of 1000˜1200° C. using 100% rutile-phase TiO₂ powder particles at a calcination temperature of 1200° C. This is attributed to the particles (FIG. 6, (c-4)) that were already coarsely and abnormally grown in the 100% rutile-phase TiO₂ powder calcined at a temperature of 1200° C. That is, the presence of large-sized particles in the initial stage generally reduces the grain growth driving force, so that during sintering, only some large particles continue to grow, whereas relatively small particles are unable to grow. This ultimately results in lowering the sintering density and the densification of the solid solution. Such a phenomenon also occurs at calcination temperatures exceeding 1200° C.

As described above, in BaZrTiO₃ dielectric ceramics manufactured by applying anatase/brookite/rutile triphase core/shell TiO₂ powder as a starting material according to the present invention, higher grain growth is observed, whereas in BaZrTiO₃ dielectric ceramics manufactured by applying a single-phase TiO₂ powder as a starting material as in the prior art show none or little of grain growth. This leads to the following dielectric properties.

### Dielectric Properties of BaZrTiO₃ Solid Solution

In the present invention, the temperature range for synthesizing BaZrTiO₃ using the anatase/brookite/rutile triphase core/shell TiO₂ powder is approximately 1000 to 1400° C., and based on the examples of FIGS. 6 to 8, the temperature range is preferably approximately 1000 to 1200° C., more preferably approximately 1000° C.

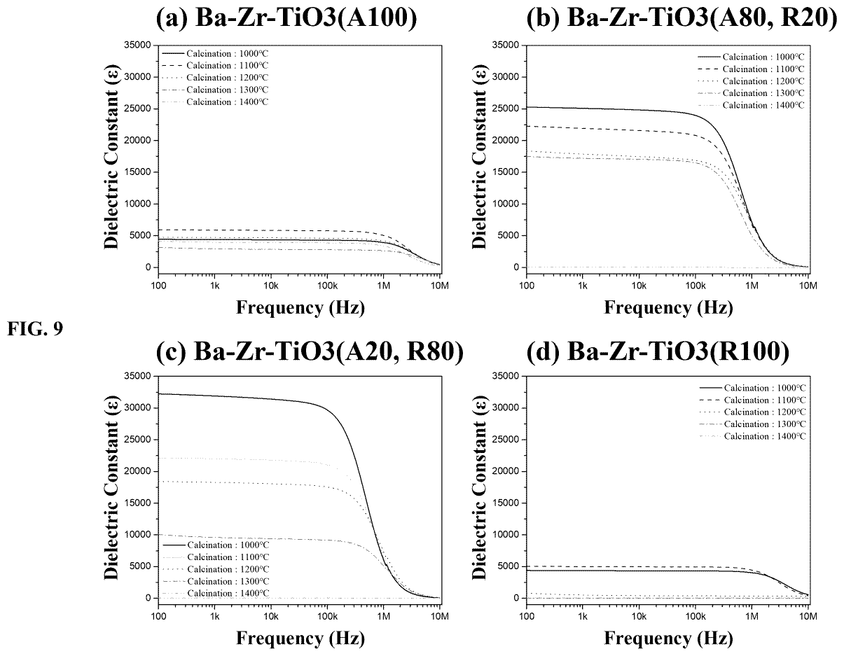

FIG. 9 is a graph showing the change in dielectric constant (ε) of BaZrTiO₃ solid solutions by the composition and by the calcination temperature, which were manufactured by sintering BaZrTiO₃ bulks formed by molding BaZrTiO3 powders calcined according to each composition in FIG. 6 at about 1300° C. for 2 hours in an air atmosphere, respectively, according to embodiments of the present invention. Here, (a) to (d) are each of the BaZrTiO₃ solid solutions manufactured by applying composite-phase TiO₂ powders as starting materials with varied anatase-phase:rutile-phase fractions, wherein (a) indicates the case when an anatase single-phase TiO₂ powder of a 100:0 anatase:rutile phase fraction was applied as a starting material, (b) indicates the case when an anatase/brookite/rutile triphase core/shell TiO₂ powder of a 80:20 anatase:rutile phase fraction was applied as a starting material, and (c) indicates the case when an anatase/brookite/rutile triphase core/shell TiO₂ powder of a 20:80 anatase:rutile phase fraction was applied as a starting material, and (d) indicates the case when a rutile single-phase TiO₂ powder of 0:100 anatase:rutile phase fraction was applied as starting materials, respectively.

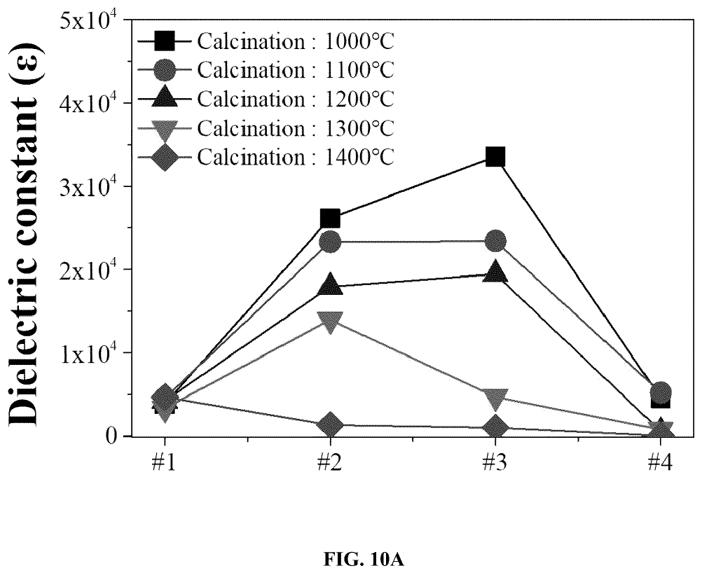

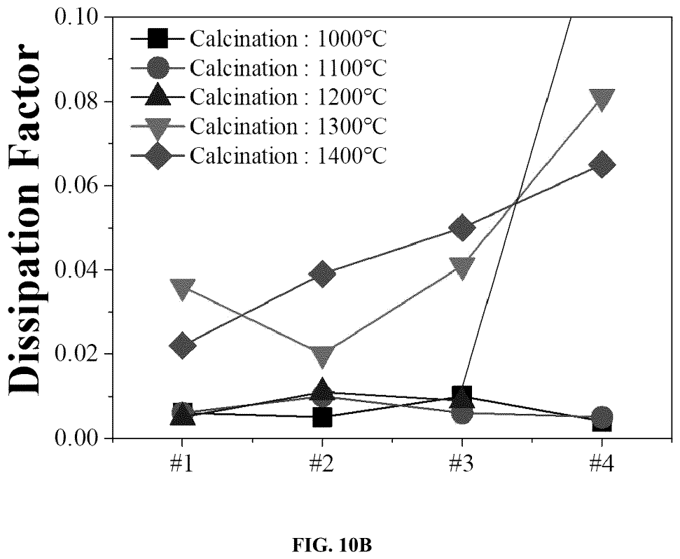

Also, FIGS. 10A˜10B are graphs showing changes in dielectric properties by composition and by calcination temperature of BaZrTiO₃ solid solutions which were manufactured by molding BaZrTiO₃ powders calcined by each composition in FIG. 5 to form BaZrTiO₃ bulks and sintering the BaZrTiO₃ bulks at about 1300° C. for 2 hours in an air atmosphere, according to embodiments of the present invention. FIG. 10A shows the changes in dielectric constant (ε) and FIG. 10B shows the changes in dissipation factor. Here, #1˜#4 are each of the BaZrTiO₃ solid solutions manufactured by applying TiO₂ powders as starting materials with varying anatase:rutile phase fractions, wherein #1 indicates the case when anatase single-phase TiO₂ powder of a 100:0 anatase:rutile phase fraction was applied as starting materials, #2 indicates the case when anatase/brookite/rutile triphase core/shell TiO₂ powder of a 85:15 anatase:rutile phase fraction was applied as starting materials, #3 indicates the case when anatase/brookite/rutile triphase core/shell TiO₂ powder of a 13:87 anatase:rutile phase fraction was applied as starting materials, and #4 indicates the case when anatase single-phase TiO₂ powder of a 0:100 anatase:rutile phase fraction was applied as starting materials, respectively.

Also, Table 1 below is that summarizes the dielectric loss values by each calcination temperature of each BaZrTiO₃ solid solution manufactured by employing TiO₂ powder with varied anatase-phase:rutile-phase fractions as shown in FIG. 10B, according to embodiments of the present invention.

TABLE 1
Dielectric loss by calcination temperature of each BaZrTiO₃ solid solution

| Calcination temperature | 1000° C. | 1100° C. | 1200° C. | 1300° C. | 1400° C. |
|---|---|---|---|---|---|
| #1 BaZrTiO₃ solid solution employing | 6 × 10⁻³ | 6 × 10⁻³ | 5 × 10⁻³ | 3 × 10⁻² | 2 × 10⁻² |
| 100% anatase single-phase TiO₂ powder as | | | | | |
| starting material | | | | | |
| #2 BaZrTiO₃ solid solution employing 85% | 5 × 10⁻³ | 1 × 10⁻² | 1 × 10⁻² | 2 × 10⁻² | 4 × 10⁻² |
| anatase and 15% rutile- triphase core/shell | | | | | |
| TiO₂ powder as starting material | | | | | |
| #3 BaZrTiO₃ solid solution employing 13% | 1 × 10⁻³ | 6 × 10⁻³ | 9 × 10⁻³ | 4 × 10⁻² | 5 × 10⁻² |
| anatase and 87% rutile- triphase core/shell | | | | | |
| TiO₂ powder as starting material | | | | | |
| #4 BaZrTiO₃ solid solution employing | 4 × 10⁻³ | 5 × 10⁻³ | | 8 × 10⁻² | 6 × 10⁻² |
| 100% rutile single-phase TiO₂ powder as | | | | | |
| starting material | | | | | |

Looking at the dielectric characteristic behaviors shown in FIGS. 9 and 10A˜10B and Table 1, the BaZrTiO₃ solid solution manufactured by employing 100% anatase single-phase TiO₂ powder or 100% rutile single-phase TiO₂ powder as a starting material generally exhibits low levels of dielectric properties, i.e., low dielectric constant and high dielectric loss.

On the contrary, in the cases of the BaZrTiO₃ solid solution manufactured by employing the anatase/brookite/rutile triphase core/shell TiO₂ powder as a starting material according to the present invention, significantly improved excellent dielectric properties are implemented. In particular, when calcined at the temperature range of 1000 to 1100° C., an ultra-high dielectric constant of approximately 2.0×10⁴ to 3.3×10⁴ (approximately 33,560 at maximum) and an ultra-low dielectric loss of approximately 1×10⁻³ at minimum are achieved.

As described above, in the present invention, in manufacturing a dielectric ceramic having a composition formula of BaZrTiO₃, a single-phase anatase TiO₂ powder is initially selected as the TiO₂ raw material. This TiO₂ raw material is then heat-treated under predetermined conditions to deliberately induce internal phase transformations, resulting in an anatase/brookite/rutile composite-phase core/shell TiO₂ powder, which is subsequently employed as the TiO₂ starting material. This triphase core/shell TiO₂ powder is then mixed with Ba and Zr raw material powders according to the composition formula, calcined and then sintered to form a solid solution, thereby manufacturing a BaZrTiO₃ dielectric ceramics.

According to the present invention, by employing the triphase core/shell TiO₂ powder as a starting material, the resulting BaZrTiO₃ dielectric ceramics exhibit remarkably large grain growth in their internal structure, along with their significantly improved dielectric properties compared to conventional BaZrTiO₃ dielectric ceramics that employ a single-phase TiO₂ powder of anatase-phase or rutile-phase as a starting material, achieving an ultra-high dielectric constant and ultra-low dielectric loss.

Such a BaZrTiO₃ colossal dielectric constant material according to the present invention has an ultra-high dielectric constant of up to about 33,560 and a very low dielectric loss of about 1×10⁻³ at minimum. Hence, it can be very advantageously applied to various high-performance electronic devices and energy storage and conversion devices.

Above, in the above-described embodiments and examples of the present invention, it is quite obvious to those skilled in the art that there may be some variation within a typical margin of error depending on powder properties such as average particle size, distribution and specific surface area of a composition powder, the purity of raw materials, the amount of added impurities and the sintering conditions.

Furthermore, preferred embodiments and examples of the present invention as disclosed serve illustrative purposes. Those skilled in the art will be able to make various modifications, changes, additions within the spirit and scope of the present invention, and all such modifications, changes and additions are intended to be included within the scope of the appended claims.

What is claimed is:

1. A method for manufacturing BaZrTiO₃ dielectric ceramics, the method comprising the following steps:
(i) preparing for BaCO₃ raw material powder, TiO₂ raw material powder, and ZrO₂ raw material powder, respectively, wherein the TiO₂ raw material powder is prepared as an anatase single-phase TiO₂ powder;
(ii) producing a composite-phase TiO₂ powder by heat-treating the anatase single-phase TiO₂ powder to induce a phase transition, so that the internal structure of a particle of the composite-phase TiO₂ powder is composed of a core/shell structure in which an anatase-phase TiO₂ region/a brookite-phase TiO₂ region/a rutile-phase TiO₂ region are laminated, wherein the brookite-phase TiO₂ region is a hybrid region in which the anatase-phase TiO₂ region and the rutile-phase TiO₂ region are coexisting;
(iii) mixing the BaCO₃ raw material powder, the composite-phase TiO₂ powder, and the ZrO₂ raw material powder, and heat-treatment calcining the mixed powder to synthesize BaZrTiO₃ powder; and
(iv) molding the synthesized BaZrTiO₃ powder and sintering the molded body to form a BaZrTiO₃ solid solution.

2. The method of claim 1, wherein in the core/shell structure of the composite-phase TiO₂ powder in the step (ii), from the core towards the shell, the occupancy of the anatase-phase TiO₂ region progressively decreases, while that of the rutile-phase TiO₂ region progressively increases.

3. The method of claim 1, wherein in the core/shell structure of the composite-phase TiO₂ powder in the step (ii), the ratio of the occupancy of the anatase-phase TiO₂ region to that of the rutile-phase TiO₂ region is adjusted in the range of 10:90 to 90:10.

4. The method of claim 1, wherein in the core/shell structure of the composite-phase TiO₂ powder in the step (ii), the ratio of the occupancy of the anatase-phase TiO₂ region to that of the rutile-phase TiO₂ region is adjusted by controlling the temperature of the heat-treating in the step (ii).

5. The method of claim 4, wherein the temperature of the heat-treating in the step (ii) is controlled within a range of 600 to 900° C.

6. The method of claim 5, wherein the heat-treating in the step (ii) is performed for 5 to 9 hours.

7. The method of claim 1, wherein the heat-treatment calcining in the step (iii) is performed at a temperature range of 1000 to 1400° C.

8. The method of claim 1, wherein the sintering in the step (iv) is performed at a temperature range of 1000 to 1400° C.

9. The method of claim 1, wherein the heat-treating in the step (ii) is performed at a temperature range of 600 to 900° C. and the heat-treatment calcining in the step (iii) is performed at a temperature range of 1000 to 1100° C., and wherein the BaZrTiO₃ solid solution sintered in the step (iv) has a dielectric constant in the range of 2.0×10⁴ to 3.3×10⁴.

10. The method of claim 1, wherein the dielectric constant and/or the dielectric loss of the BaZrTiO₃ solid solution in the step (iv) is controlled by adjusting the temperature of the heat-treating in the step (ii) to adjust the ratio of the occupancy of the anatase-phase TiO₂ region to that of the rutile-phase TiO₂ region in the core/shell structure.

11. The method of claim 10, wherein the dielectric constant and/or the dielectric loss of the BaZrTiO₃ solid solution in the step (iv) is further controlled by adjusting the temperature the heat-treatment calcining in the step (iii).

12. The method of claim 1, wherein the molding in the step (iv) is performed by at least one of dry molding, uniaxial molding, cold isostatic pressing (CIP), extrusion forming, or tape casting.

13. The method of claim 1, wherein the synthesized BaZrTiO₃ powder in the step (iii) is processed into a slurry in which the synthesized BaZrTiO₃ powder is dispersed in a solvent, and wherein the molding in the step (iv) comprises:
tape casting the slurry to form a plurality of green sheets, and printing metal electrode patterns on the surface(s) of at least one of the plurality of green sheets; and
laminating and pressing the plurality of green sheets to form a monolithic body.
